(19) United States
(12) Patent Application Publication
(10) Pub. No.: US 2024/0106092 A1
(43) Pub. Date: Mar. 28, 2024

(54) BATTERY PACK AND ADAPTER

(71) Applicant: MAKITA CORPORATION, Anjo-shi (JP)

(72) Inventors: Hironori OGURA, Anjo-shi (JP); Tatsuya NAGAHAMA, Anjo-shi (JP)

(73) Assignee: MAKITA CORPORATION, Anjo-shi (JP)

(21) Appl. No.: 18/464,502

(22) Filed: Sep. 11, 2023

(30) Foreign Application Priority Data
Sep. 22, 2022 (JP) 2022-151879

(51) Int. Cl. H01M 50/559; H01M 10/42; H01M 50/247; H01M 50/55; H01M 50/562

(52) U.S. Cl. CPC H01M 50/559; H01M 10/4257; H01M 50/247; H01M 50/55; H01M 50/562

(57) ABSTRACT

A battery pack may be configured to be attached to and detached from an electric device including a plurality of device-side terminals. The battery pack may include: an outer case; a battery cell; a circuit board; and a plurality of battery-side terminals. A first terminal of the plurality of battery-side terminals may include a clamp portion and a non-clamp portion. The clamp portion may be configured to receive a device-side terminal of the plurality of device-side terminals and clamp the device-side terminal from both sides. An inner surface of the clamp portion may be plated with a first metal. A part of a surface of the non-clamp portion may not be plated with the first metal. The first metal may be a pure metal that is a noble metal or a noble metal alloy.

### REFERENCE TO RELATED APPLICATIONS

This application claims priority from Japanese Patent Application No. 2022-151879 filed on Sep. 22, 2022. The entire content of the priority application is incorporated herein by reference.

### BACKGROUND ART

International Publication No. WO 2021/065688 describes a battery pack configured to be detachably attached to an electric device including a plurality of device-side terminals having a planar shape. The battery pack includes an outer case, a battery cell housed within the outer case, a circuit board housed within the outer case, and a plurality of battery-side terminals.

### DESCRIPTION

In the battery pack as aforementioned, in a state in which the battery pack is attached to the electric device, the battery-side terminals are maintained in contact with the device-side terminals of the electric device. In this state, when micro-vibration is repeatedly applied to the battery-side terminals, partial wear progresses on surfaces of the battery-side terminals, by which metal debris worn off of the surfaces of the battery-side terminals oxidizes and accumulates on the surfaces of the battery-side terminals. Such a phenomenon is called fretting corrosion. As the oxidized debris accumulates on the surfaces of the battery-side terminals, conduction defects of the battery-side terminals could occur.

The present teachings provide an art configured to suppress conduction defects in battery-side terminal(s).

A battery pack disclosed herein may be configured to be attached to and detached from an electric device including a plurality of device-side terminals having a planar shape. The battery pack may comprise an outer case; a battery cell housed within the outer case; a circuit board housed within the outer case; and a plurality of battery-side terminals, wherein the plurality of battery-side terminals incudes a first terminal, the first terminal includes a clamp portion and a non-clamp portion, the clamp portion being configured to receive a device-side terminal of the plurality of device-side terminals and clamp the device-side terminal from both sides, and the non-clamp portion being disposed at a position different from the clamp portion, an inner surface of the clamp portion is plated with a first metal; a part of a surface of the non-clamp portion is not plated with the first metal, wherein the first metal is a pure metal that is a noble metal or a noble metal alloy.

Further, an adapter disclosed herein may be configured to be attached to and detached from an electric device including a plurality of device-side terminals having a planar shape. The adapter may comprise an outer case; a circuit board housed within the outer case; a connected portion electrically connected with the circuit board; and a plurality of adapter-side terminals, wherein the plurality of adapter-side terminals incudes a first terminal, the first terminal includes a clamp portion and a non-clamp portion, the clamp portion being configured to receive a device-side terminal of the plurality of device-side terminals and clamp the device-side terminal from both sides, and the non-clamp portion being disposed at a position different from the clamp position, at least a part of a surface of the clamp portion is plated with a first metal, a part of a surface of the non-clamp portion is not plated with the first metal, and the first metal is a pure metal that is a noble metal or a noble metal alloy.

In general, noble metals tend not to oxidize, thus they are resistant against such conduction defects caused by the fretting corrosion. To the contrary, since base metals are prone to oxidization, they are susceptible to such conduction defects caused by the fretting corrosion. Accordingly, occurrence of conduction defects due to fretting corrosion can be suppressed by plating inner surfaces of the clamp portion of the first terminal with a pure metal that is a noble metal or a noble metal alloy. Also, generally, the noble metals are expensive. According to the above configuration, compared to a configuration where a part of the surface of the non-clamp portion of the first terminal is also plated with the first metal, manufacturing costs of a battery pack and an adapter can be reduced.

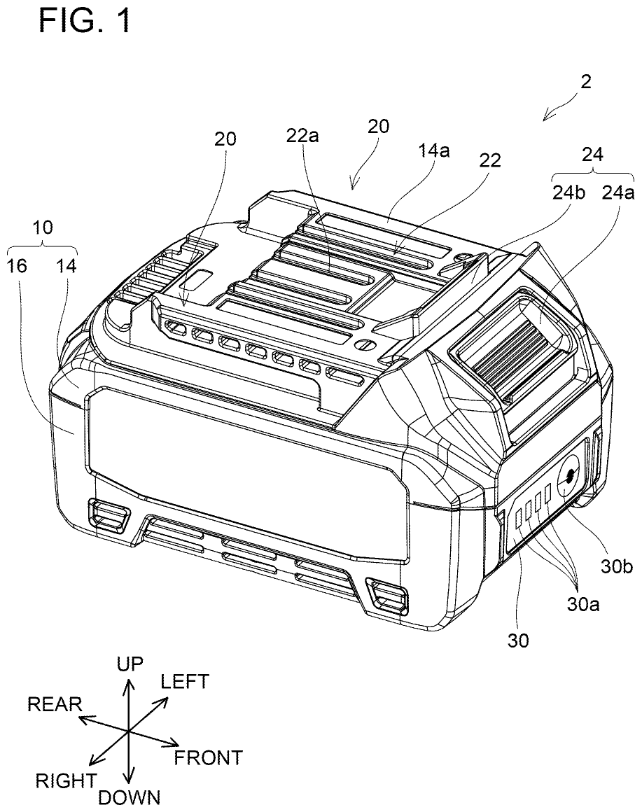

FIG. 1 is a perspective view of a battery pack 2 according to the first embodiment from a front right upper side.

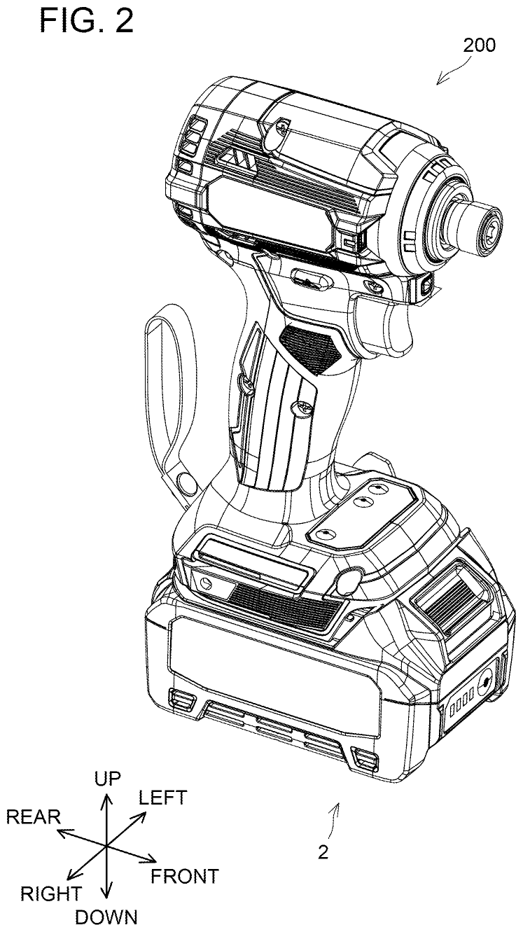

FIG. 2 is a perspective view of the battery pack 2 according to the first embodiment in a state attached to a power tool 200 from the front right upper side.

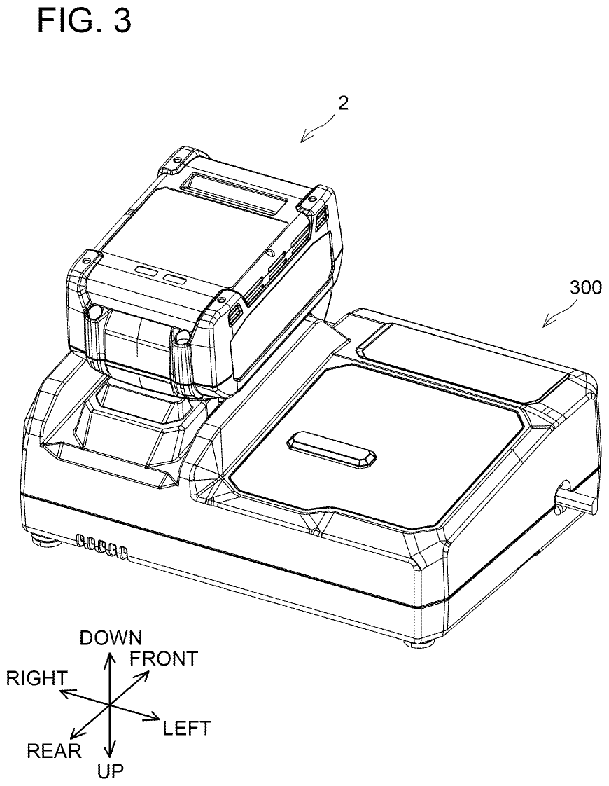

FIG. 3 is a perspective view of the battery pack 2 according to the first embodiment in a state attached to a charger 300 from a rear left lower side.

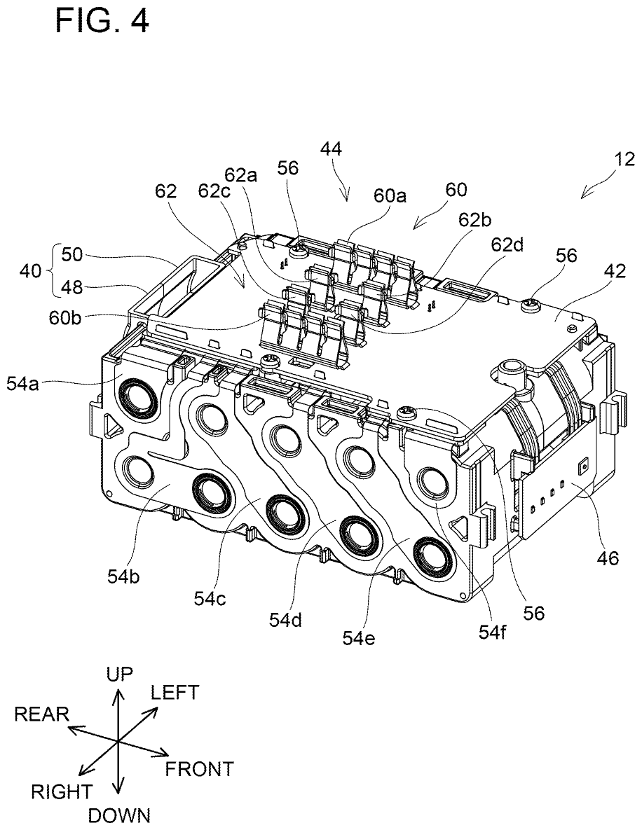

FIG. 4 is a perspective view of a battery module 12 according to the first embodiment from the front right upper side.

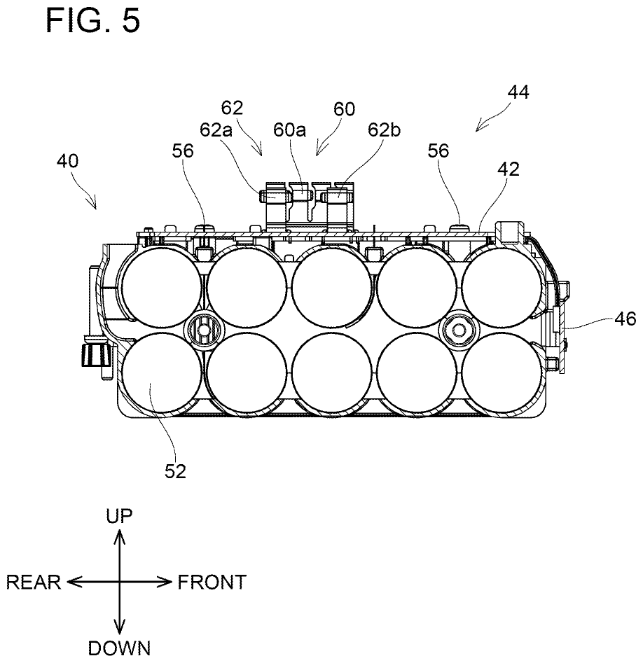

FIG. 5 is a cross-sectional view of the battery module 12 according to the first embodiment from right side.

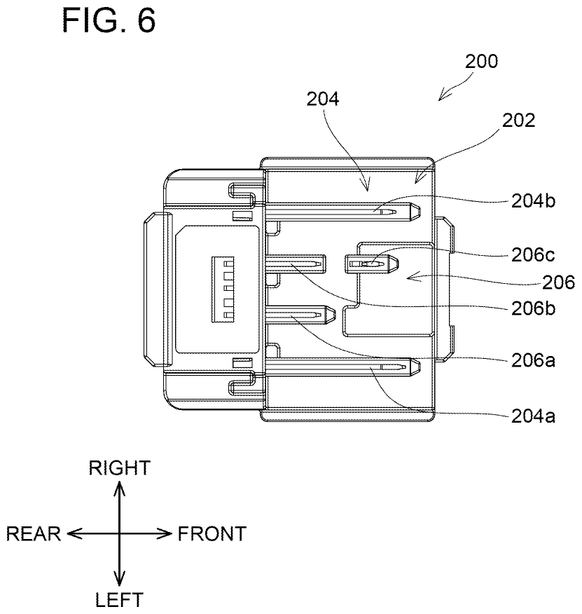

FIG. 6 is a schematic view of a plurality of terminals 202 of the power tool 200 according to the first embodiment.

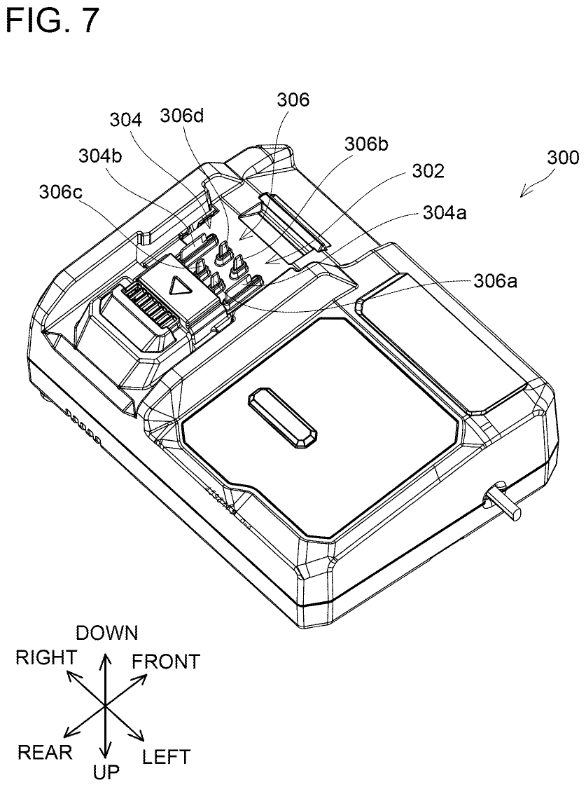

FIG. 7 is a perspective view of the charger 300 according to the first embodiment from the rear left lower side.

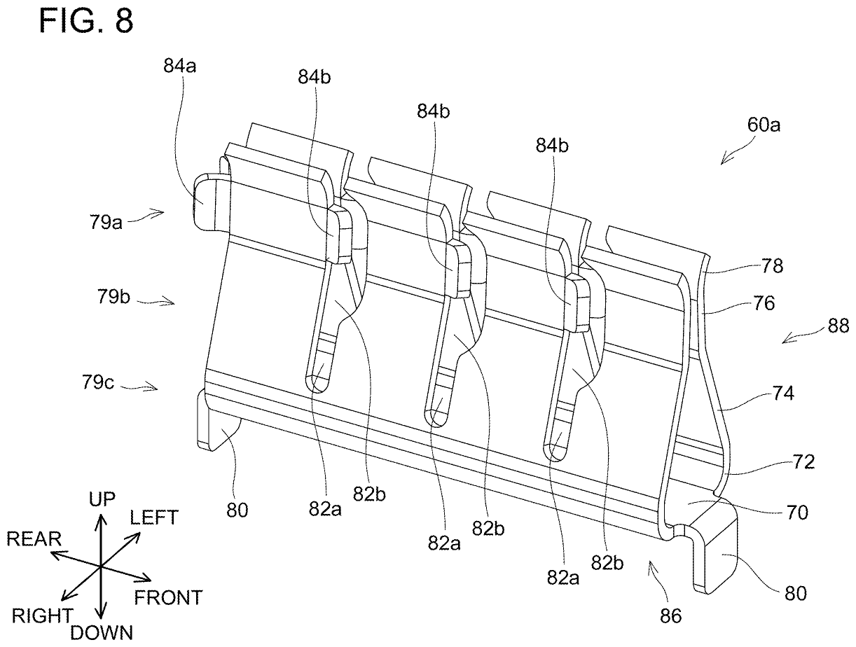

FIG. 8 is a perspective view of a first positive power terminal 60a according to the first embodiment from the front right upper side.

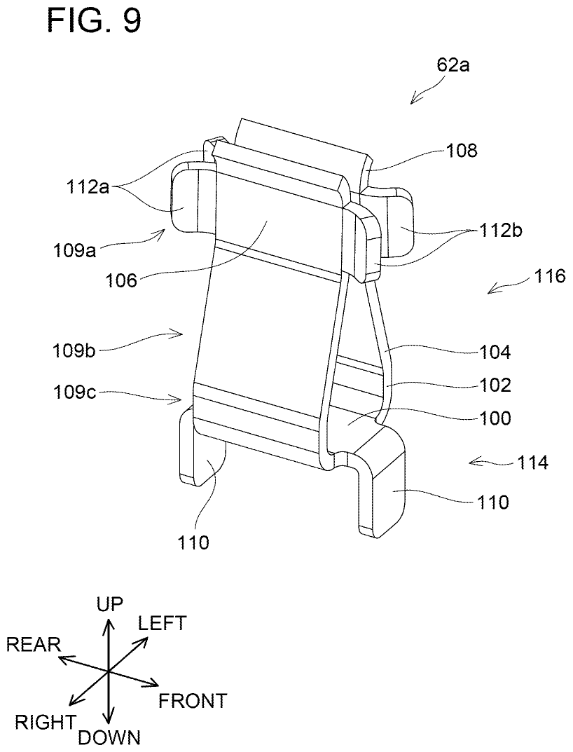

FIG. 9 is a perspective view of a first connection detection terminal 62a according to the first embodiment from the front right upper side.

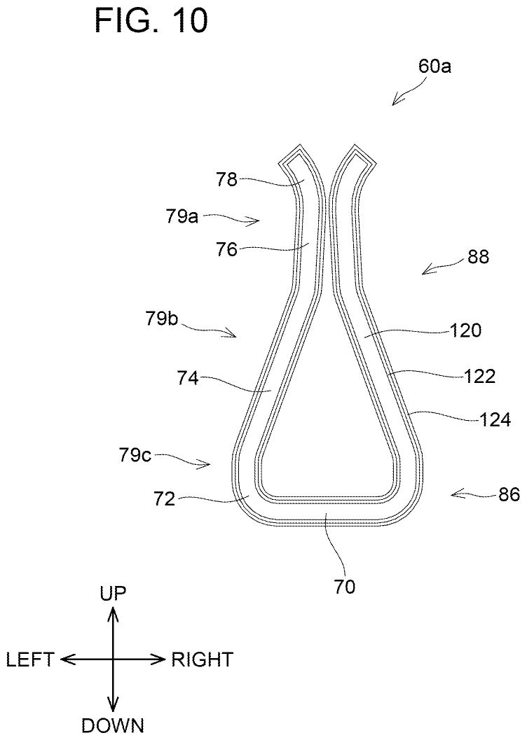

FIG. 10 illustrates an over view of plating applied on the first positive power terminal 60a according to the first embodiment.

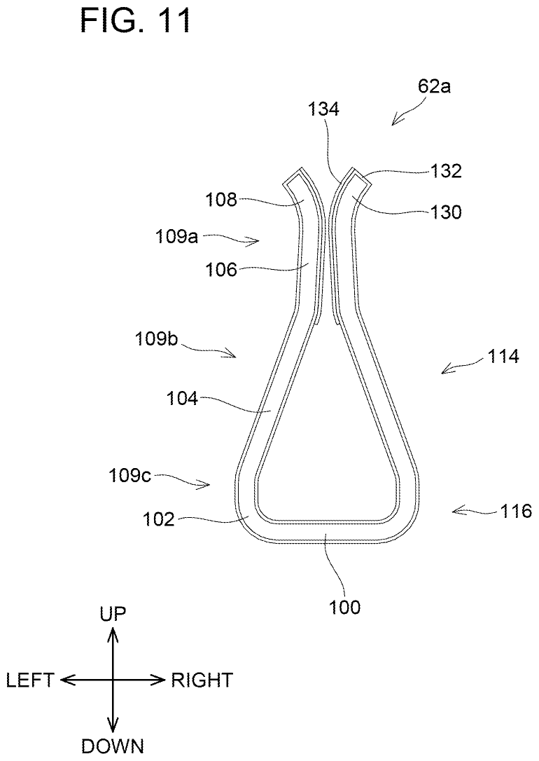

FIG. 11 illustrates an over view of plating applied on the first connection detection terminal 62a according to the first embodiment.

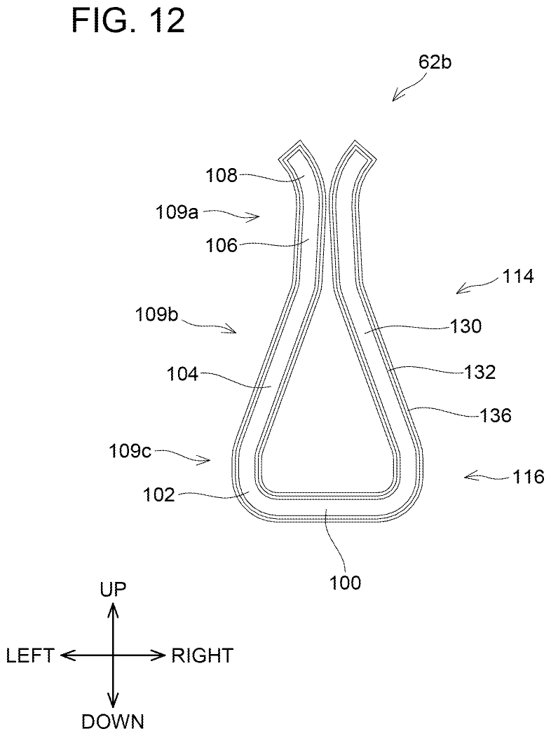

FIG. 12 illustrates an over view of plating applied on a first charge control terminal 62b according to the first embodiment.

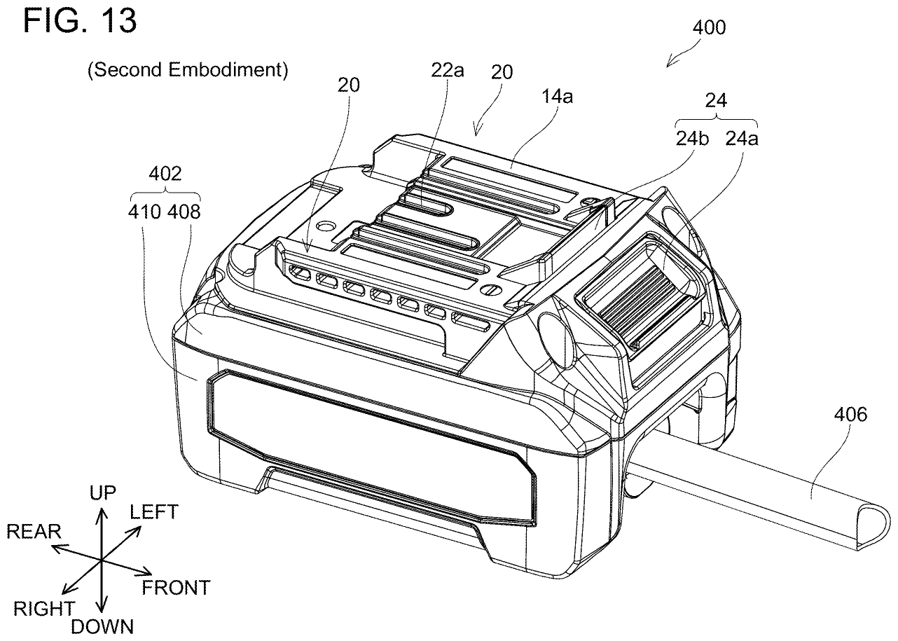

FIG. 13 is a perspective view of an adapter 400 according to a second embodiment from the front right upper side.

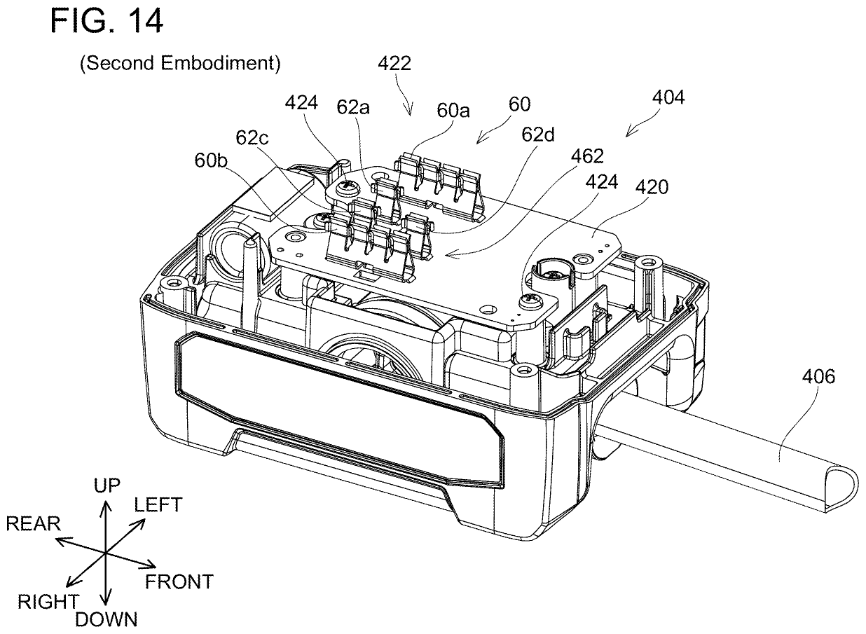

FIG. 14 is a perspective view of the adapter 400 according to the second embodiment with an upper case 408 removed, from the front right upper side.

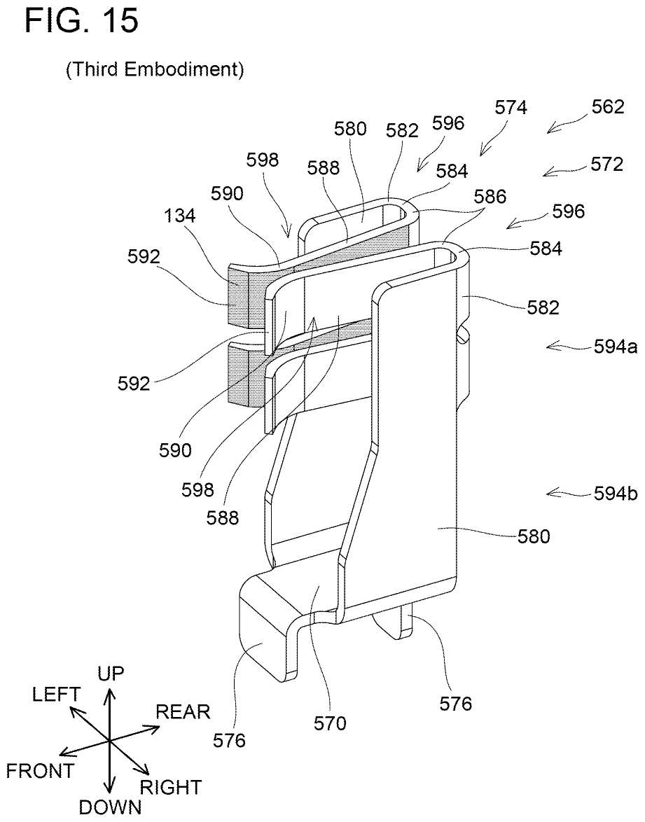

FIG. 15 is a perspective view of a signal terminal 562 according to a third embodiment from the front right upper side.

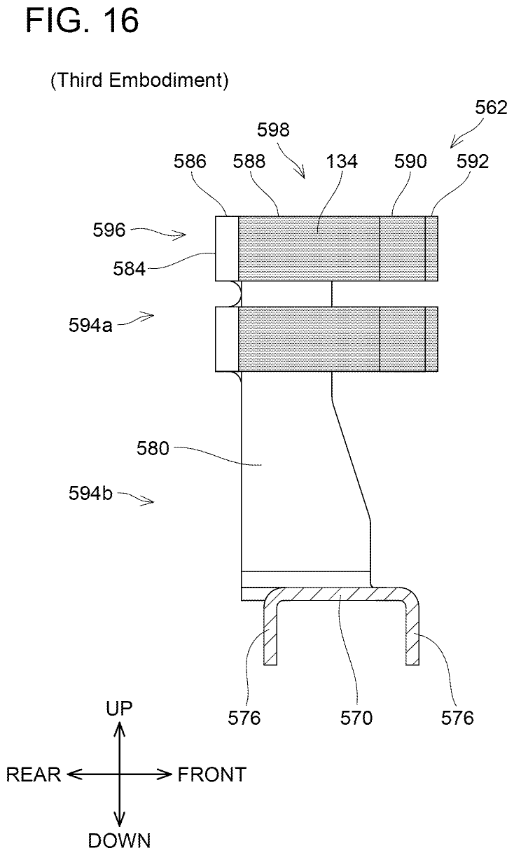

FIG. 16 is a cross-sectional view of the signal terminal 562 according to the third embodiment from left side.

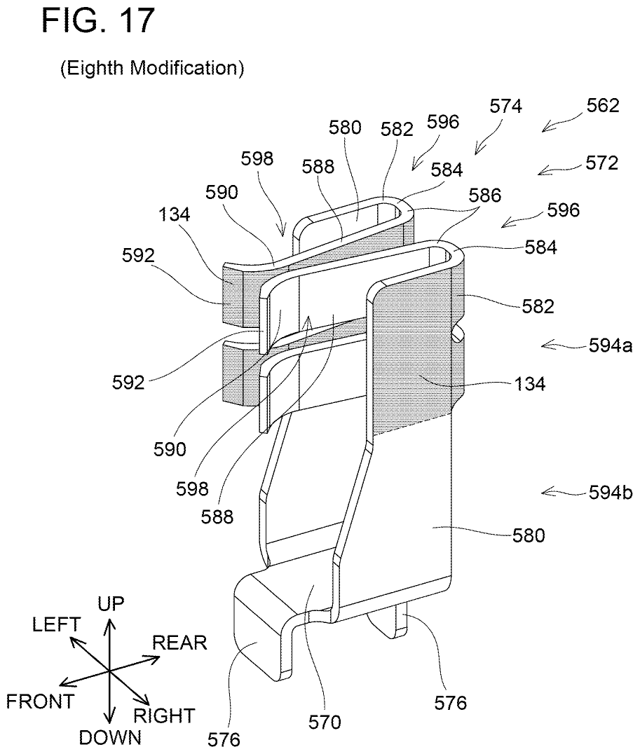

FIG. 17 is a perspective view of the signal terminal 562 according to an eighth modification from the front right upper side.

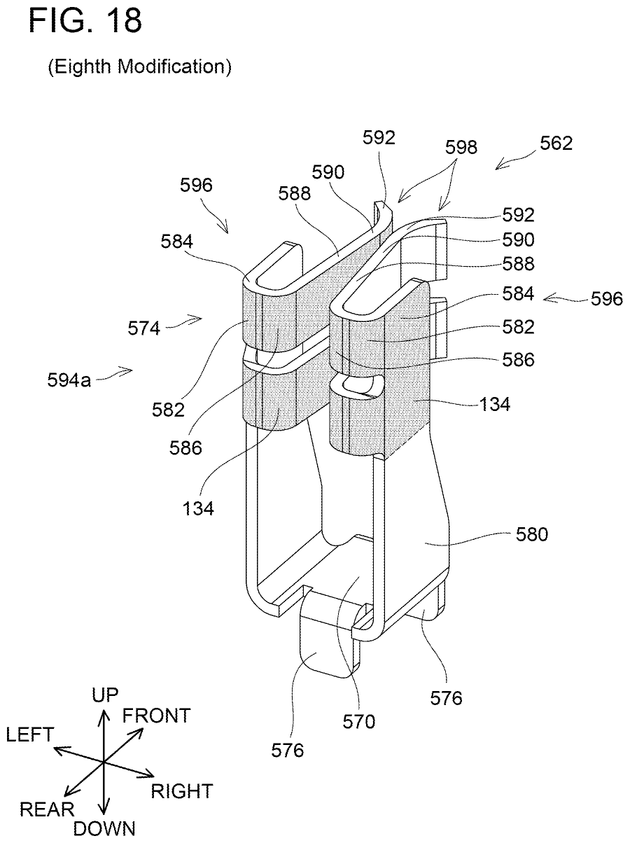

FIG. 18 is a perspective view of the signal terminal 562 according to the eighth modification from the rear right upper side.

Representative, non-limiting examples of the disclosure herein will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved battery packs and adapters, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the below-described representative examples, as well as the various independent and dependent claims, may be combined in ways that are not specifically and explicitly enumerated in order to provide additional useful embodiments of the present teachings.

Moreover, combinations of features and steps disclosed in the following detailed description may not be necessary to practice the invention in the broadest sense, and are instead taught merely to particularly describe representative examples of the invention. Furthermore, various features of the below-described representative examples, as well as the various independent and dependent claims, may be combined in ways that are not specifically and explicitly enumerated in order to provide additional useful embodiments of the present teachings.

In one or more embodiments, a battery pack disclosed herein may be configured to be attached to and detached from an electric device including a plurality of device-side terminals having a planar shape. The battery pack may comprise an outer case; a battery cell housed within the outer case; a circuit board housed within the outer case; and a plurality of battery-side terminals. The plurality of battery-side terminals may include a first terminal. The first terminal may include a clamp portion and a non-clamp portion, the clamp portion being configured to receive a device-side terminal of the plurality of device-side terminals and clamp the device-side terminal from both sides, and the non-clamp portion being disposed at a position different from the clamp portion. An inner surface of the clamp portion may be plated with a first metal. A part of a surface of the non-clamp portion may not be plated with the first metal. The first metal may be a pure metal that is a noble metal or a noble metal alloy.

In one or more embodiments, an adapter may be configured to be attached to and detached from an electric device including a plurality of device-side terminals having a planar shape. The adapter may comprise an outer case; a circuit board housed within the outer case; a connected portion electrically connected with the circuit board; and a plurality of adapter-side terminals. The plurality of adapter-side terminals may include a first terminal. The first terminal may include a clamp portion and a non-clamp portion, the clamp portion being configured to receive a device-side terminal of the plurality of device-side terminals and clamp the device-side terminal from both sides, and the non-clamp portion being disposed at a position different from the clamp position. At least a part of a surface of the clamp portion may be plated with a first metal. A part of a surface of the non-clamp portion may not be plated with the first metal. The first metal may be a pure metal that is a noble metal or a noble metal alloy.

In one or more embodiments, the first terminal may be a terminal for transmitting a signal to and from the electric device.

Further, the conduction defects caused by the fretting corrosion tend not to occur when a large voltage is applied whereas the conduction defects tend to occur when a small voltage is applied, thus the conduction defects tend to occur in the signal terminal(s). According to the above configuration, occurrence of the conduction defects due to fretting corrosion can be suppressed by plating the surface of the first terminal which is a signal terminal with a pure metal that is a noble metal or a noble metal alloy.

In one or more embodiments, the plurality of battery-side terminals may further include a second terminal for transmitting a signal to and from the electric device. The second terminal may not be plated with the first metal.

The plurality of signal terminals comprised by the battery pack includes a signal terminal which is susceptible to fretting corrosion and a signal terminal which is insusceptible to fretting corrosion. The first terminal is a signal terminal which is more susceptible to fretting corrosion than the second terminal. According to the above configuration, the first terminal more susceptible to fretting corrosion is preferentially plated with the first metal. Accordingly, the effects by fretting corrosion can be suppressed and also manufacturing costs of a battery pack can be decreased.

In one or more embodiments, in a case where the electric device is a power tool, the plurality of device-side terminals of the power tool may include a first device-side terminal. Under a state where the battery pack is attached to the power tool, the first device-side terminal may be in contact with the first terminal, and none of the plurality of device-side terminals of the power tool may be in contact with the second terminal. In a case where the electric device is a charger, the plurality of device-side terminals of the power tool may include a second device-side terminal and a third device-side terminal different from the second device-side terminal. Under a state where the battery pack is attached to the charger, the second device-side terminal may be in contact with the first terminal, and the third device-side terminal may be in contact with the second terminal.

Micro vibration is less likely when a battery pack is attached to a charger than when the battery pack is attached to a power tool. Due to this, fretting corrosion is less likely on the second terminal which contacts the third device-side terminal of the charger but not contact any terminal of the power tool. That is, the second terminal is a signal terminal which is less susceptible to fretting corrosion than the first terminal. Due to this, there is less necessity for plating the second terminal with the first metal. According to the above configuration, the second terminal is not plated with the first metal. Accordingly, the effects by fretting corrosion can be suppressed, and also manufacturing costs of a battery pack can be decreased.

In one or more embodiments, the first terminal may be a terminal for transmitting a discharge enable signal or a discharge disable signal to and from the electric device.

The first terminal, which is a terminal for transmitting a discharge enable signal or a discharge disable signal to and from the electric device, is more susceptible to fretting corrosion than the second terminal is. According to the above configuration, the first terminal more susceptible to fretting corrosion is preferentially plated with the first metal. Accordingly, the effects by fretting corrosion can be suppressed and also manufacturing costs of a battery pack can be decreased.

In one or more embodiments, an outer surface of the clamp portion may not be plated with the first metal.

The inner surface of the clamp portion contacts the device-side terminal, while the outer surface of the clamp portion does not contact the device-side terminal. Due to this, fretting corrosion occurs on the inner surface of the clamp portion but it does not occur on the outer surface of the clamp portion. According to the above configuration, the inner surface of the clamp portion where fretting corrosion occurs is only plated with the first metal, and accordingly manufacturing costs of a battery pack can be decreased as compared to the configuration where the outer surface of the clamp portion is also plated with the first metal.

In one or more embodiments, the first metal may be Ag.

A contact resistance of Ag is smaller than a contact resistance of Sn. Accordingly, the plating of Ag allows the contact resistance of the first terminal to be reduced.

In one or more embodiments, the battery pack/adapter may be configured to be attached to and detached from the electric device by sliding the battery pack/adapter with respect to the electric device in a sliding direction along the device-side terminals. Each of the battery-side terminals/adapter-side terminals may include: a base portion; and a pair of elastic clamping pieces extending from the base portion upward which is orthogonal to the sliding direction. The base portion may include a bottom plate portion extending along the sliding direction. Each of the elastic clamping pieces in the pair may include an inclined portion and the clamp portion disposed above the inclined portion. The inclined portion may be inclined with respect to the bottom plate portion such that an angle formed by the inclined portion and the bottom plate portion is an acute angle. The base portion and the inclined portion may be a part of the non-clamp portion.

According to the above configuration, each of the pairs of elastic clamping pieces extends in the up-down direction. Accordingly, in order to increase a contact area between the device-side terminals and the battery-side terminals/adapter-side terminals, a width of the pairs of elastic clamping pieces may be increased. Normally, there is often an enough space in the slide direction inside a battery pack/adapter. Accordingly, even when the width of the pairs of elastic clamping pieces is increased in the slide direction, size of the battery pack/adapter will not be increased. According to the above battery pack/adapter, without increase in the size of the battery pack/adapter, the contact area between the device-side terminals and the battery/side terminals/adapter-side terminals can be increased.

In one or more embodiments, the battery pack/adapter maybe configured to be attached to and detached from the electric device by sliding the battery pack/adapter with respect to the electric device in a sliding direction along the device-side terminals. Each of the battery-side terminals/adapter-side terminals may include: a pair of planar portions connected to the circuit board; and a pair of elastic clamping pieces integrated with the pair of planar portions, disposed above the circuit board, and extending in the sliding direction. Each of the elastic clamping pieces in the pair may include the clamp portion. A part of the pair of planar portions which is closer to the circuit board may be a part of the non-clamp portion.

According to the above configuration, each of the pairs of elastic clamping pairs extends in the slide direction. According to such configuration, the device-side terminals of the electric device can be easily slid between the pairs of elastic clamping pieces.

### FIRST EMBODIMENT

A battery pack 2 shown in FIG. 1 is configured to be attached to and detached from a power tool 200 (see FIG. 2) or a charger 300 (see FIG. 3). FIG. 2 illustrates a case where the power tool 200 is an electric driver. The power tool 200 may be an electric drill, an electric grinder, an electric circular saw, an electric chainsaw, an electric reciprocating saw, an electric lawn mower, an electric grasscutter, an electric blower, for example. In the following description, with respect to the battery pack 2, when the battery pack 2 is attached to the power tool 200, a direction in which the power tool 200 is located as seen from the battery pack 2 will be referred to as upward, and its opposite direction will be referred to as downward. Further, with respect to the battery pack 2, when the battery pack 2 is attached to the power tool 200, a direction in which the battery pack 2 is slid will be referred to as rearward, and a direction to which the battery pack 2 is slid to be removed from the power tool 200 will be referred to as frontward.

As shown in FIG. 1, the battery pack 2 comprises an outer case 10 and a battery module 12 (see FIG. 4) housed within the outer case 10. The outer case 10 has a shape of a substantially cuboid as a whole, and is divided into an upper case 14 and a lower case 16. The upper case 14 and the lower case 16 are fixed to each other by metal screws (not shown).

The upper case 14 comprises slide rails 20, a terminal receptacle 22, and a hook 24. The slide rails 20 extend along a front-rear direction, and they are disposed on left and right ends of an upper part of the upper case 14.

The terminal receptacle 22 comprises a terminal opening 22a defined on an upper surface 14a of the upper case 14. The terminal opening 22a is arranged between the left and right slide rails 20. The hook 24 is arranged on a front upper part of the upper case 14. The hook 24 is a resin member. The hook 24 comprises an operation part 24a and a projection part 24b. The hook 24 is held by the upper case 14 movably in the up-down direction. The hook 24 is biased upward by a compression spring (not shown) and is configured to move downward when the operation part 24a and/or the projection part 24b are pressed downward. The projection part 24b engages with an engaging groove (not shown) defined on a housing of the power tool 200 or the charger 300 and thereby fixes the battery pack 2 to the power tool 200 or the charger 300 when the battery pack 2 is attached to the power tool 200 for example (see FIG. 2). When the battery pack 2 is to be detached from the power tool 200 or the charger 300, the projection part 24b moves downward by a user pressing down the operation part 24a. By sliding the battery pack 2 from this state, the battery pack 2 can be detached from the power tool 200 or the charger 300. The operation part 24a is recessed inward. Due to this, when the user places his/her finger(s) on the operation part 24a to press down the operation part 24a, the finger(s) can push down the operation part 24a without slippery of the finger(s).

An indicator 30 is arranged on a front surface of the lower case 16. The indicator 30 comprises a level indicator 30a configured to indicate a remaining battery level of the battery pack 2 to the user and a button 30b for switching between on and off of displaying of the remaining battery level.

As shown in FIG. 4, the battery module 12 comprises a cell case 40, a circuit board 42, a plurality of terminals 44, and a LED substrate 46. The cell case 40 is constituted of insulating material, such as a resin material. The cell case 40 is divided into a right cell case 48 and a left cell case 50. The LED substrate 46 is fixed to a front side of the cell case 40.

As shown in FIG. 5, the cell case 40 contains ten battery cells 52 in two rows that are stacked in the up-down direction. Each of the battery cells 52 has one end comprising a positive electrode and another end comprising a negative electrode, and is a secondary battery cell, such as a lithium-ion battery cell, having a substantially cylindrical shape. As shown in FIG. 4, right ends of the respective battery cells 52 are electrically connected to metal lead plates 54a to 54f disposed on a right side surface of the cell case 40. Left ends of the battery cells 52 are connected to metal lead plates (not shown) disposed on a left side surface of the cell case 40.

The circuit board 42 is disposed above the cell case 40. The circuit board 42 is placed over along a plane which is orthogonal to the up-down direction. The circuit board 42 is fixed to the cell case 40 with screws 56.

The plurality of terminals 44 is disposed on an upper surface of the circuit board 42. The plurality of terminals 44 comprises power terminals 60 and signal terminals 62. The power terminals 60 comprise a first positive power terminal 60a and a first negative power terminal 60b arranged on the right side of the first positive power terminal 60a. The signal terminals 62 are disposed between the first positive power terminal 60a and the first negative power terminal 60b. The signal terminals 62 comprise a first connection detection terminal 62a adjacent to and on the right side of the first positive power terminal 60a, a first charge control terminal 62b adjacent to and on the right side of the first positive power terminal 60a and in front of the first connection detection terminal 62a, a first discharge control terminal 62c adjacent to and on the right side of the first connection detection terminal 62a, and a first serial communication terminal 62d adjacent to and on the right side of the first charge control terminal 62b. As shown in FIG. 6, the power tool 200 comprises a plurality of terminals 202. The plurality of terminals 202 comprises power terminals 204 and signal terminals 206. The power terminals 204 and the signal terminals 206 each have a planar shape. The power terminals 204 comprises a second positive power terminal 204a corresponding to the first positive power terminal 60a (see FIG. 4) and a second negative power terminal 204b corresponding to the first negative power terminal 60b (see FIG. 4). The signal terminals 206 comprise a second connection detection terminal 206a corresponding to the first connection detection terminal 62a (see FIG. 4), a second discharge control terminal 206b corresponding to the first discharge control terminal 62c (see FIG. 4), and a second serial communication terminal 206c corresponding to the first serial communication terminal 62d (see FIG. 4). That is, the signal terminals 206 do not comprise a signal terminal corresponding to the first charge control terminal 62b (see FIG. 4). Further, as shown in FIG. 7, the charger 300 comprises a plurality of terminals 302. The plurality of terminals 302 comprises power terminals 304 and signal terminals 306. The power terminals 304 and the signal terminals 306 each have a planar shape. The power terminals 304 comprise a third positive power terminal 304a corresponding to the first positive power terminal 60a (see FIG. 4) and a third negative power terminal 304b corresponding to the first negative power terminal 60b (see FIG. 4). The signal terminals 306 comprise a third connection detection terminal 306a corresponding to the first connection detection terminal 62a (see FIG. 4), a third charge control terminal 306b corresponding to the first charge control terminal 62b (see FIG. 4), a third discharge control terminal 306c corresponding to the first discharge control terminal 62c (see FIG. 4), and a third serial communication terminal 306d corresponding to the first serial communication terminal 62d (see FIG. 4). Thus, the first charge control terminal 62b (see FIG. 4) is configured to be connected to the third charge control terminal 306b of the charger 300, but is configured not to be connected to any of the terminals of the power tool 200 (see FIG. 5).

As shown in FIG. 4, in the battery pack 2 of the present embodiment, the power terminals 60 have a same shape. Hereinafter, the first positive power terminal 60a will be described in detail as an example, and thus a detailed description will be omitted for the first negative power terminal 60b. Similarly, in the battery pack 2 of the present embodiment, the signal terminals 62 have a same shape. Hereinafter, the first connection detection terminal 62a will be described in detail as an example, and thus detailed descriptions will be omitted for the first charge control terminal 62b, the first discharge control terminal 62c, and the first serial communication terminal 62d.

The first positive power terminal 60a shown in FIG. 8 is fabricated by cutting and bending a planar metal plate. The first positive power terminal 60a comprises a bottom plate portion 70, a lower curved portion 72, an inclined portion 74, a clamp portion 76, and an upper curved portion 78. The clamp portion 76 and the upper curved portion 78 are arranged at a tip section 79a of the first positive power terminal 60a, the inclined portion 74 is arranged at an intermediate section 79b of the first positive power terminal 60a, and the bottom plate portion 70 and the lower curved portion 72 are arranged at a base section 79c of the first positive power terminal 60a.

The bottom plate portion 70 has a rectangular shape a longitudinal direction of which extends along the front-rear direction of the battery pack 2. The bottom plate portion 70 has its front end and rear end comprising fixation ribs 80 for fixing the first positive power terminal 60a to the circuit board 42 (see FIG. 4). The fixation ribs 80 have a shape turned downward from the front and rear ends of the bottom plate portion 70.

The lower curved portion 72 is disposed on both sides in the left-right direction of the bottom plate portion 70. The lower curved portion 72 has a shape curved upward from the both ends of the bottom plate portion 70. The inclined portion 74 has a planar shape extending upward from upper ends of the lower curved portion 72. The inclined portion 74 is inclined relative to the bottom plate portion 70 such that an angle formed by the inclined portion 74 and the bottom plate portion 70 is an acute angle. The clamp portion 76 has a planar shape in which it extends from upper ends of the inclined portion 74 by turning slightly outward therefrom. The clamp portion 76 has its inclination angle adjusted so that a surface of the clamp portion 76 is in contact with a surface of the second positive power terminal 204a (see FIG. 6) of the power tool 200 or a surface of the third positive power terminal 304a (see FIG. 7) of the charger 300 when the second positive power terminal 204a or the third positive power terminal 304a engages with the first positive power terminal 60a. The upper curved portion 78 has a shape curved outward from upper ends of the clamp portion 76.

A plurality of slits 82a is formed in the first positive power terminal 60a. Each of the slits 82a is shaped in a U letter that extends from upper ends of the upper curved portion 78 to an intermediate portion of the inclined portion 74. The inclined portion 74, the clamp portion 76, and the upper curved portion 78 that are second and third from a rear end of the first positive power terminal 60a comprise notches 82b recessed frontward. Lower ends of the notches 82b are positioned between the upper ends and lower ends of the inclined portion 74. The clamp portion 76 at the rear end of the first positive power terminal 60a has its rear end connected with rear ribs 84a. The rear ribs 84a have a shape curved rearward. Each of the clamp portion 76 at the rear end of the first positive power terminal 60a and the clamp portion 76 that are second and third from the rear end has its front end connected with front ribs 84b. The front ribs 84b have a shape curved frontward. Hereafter, the bottom plate portion 70 and the lower curved portion 72 may be collectively referred to as a base portion 86 of the first positive power terminal 60a. In addition, the inclined portion 74, the clamp portion 76, and the upper curved portion 78 may be collectively referred to as pairs of elastic clamping pieces 88 of the first positive power terminal 60a. That is, the first positive power terminal 60a comprises the base portion 86 and the plurality of pairs of elastic clamping pieces 88 extending upward from the base portion 86.

When the second positive power terminal 204a (see FIG. 6) of the power tool 200 is inserted into the first positive power terminal 60a, a front edge of the second positive power terminal 204a enters the pairs of elastic clamping pieces 88, and thereby the pairs of elastic clamping pieces 88 spread wide outward, as a result of which the second positive power terminal 204a is clamped by the pairs of elastic clamping pieces 88. At this occasion, the clamp portion 76 is pressed against the second positive power terminal 204a by elastic restoring force of the pairs of elastic clamping pieces 88, by which the first positive power terminal 60a mechanically engages with the second positive power terminal 204a and electrically connects therewith. That is, the clamp portion 76 receives the second positive power terminal 204a of the power tool 200 and clamps the second positive power terminal 204a from both sides. Conversely, when the second positive power terminal 204a of the power tool 200 is pulled out from the pairs of elastic clamping pieces 88, the first positive power terminal 60a and the second positive power terminal 204a are mechanically disengaged from each other and thus electrically disconnected. Then, the pairs of elastic clamping pieces 88 restore to their original positions by the elastic restoring force of the pairs of elastic clamping pieces 88.

The first connection detection terminal 62a shown in FIG. 9 is fabricated by cutting and bending a planar metal plate. The first connection detection terminal 62a comprises a bottom plate portion 100, a lower curved portion 102, an inclined portion 104, a clamp portion 106, and an upper curved portion 108. The clamp portion 106 and the upper curved portion 108 are arranged at a tip section 109a of the first connection detection terminal 62a, the inclined portion 104 is arranged at an intermediate section 109b of the first connection detection terminal 62a, and the bottom plate portion 100 and the lower curved portion 102 are arranged at a base section 109c of the first connection detection terminal 62a.

The bottom plate portion 100 has a rectangular shape a longitudinal direction of which extends along the front-rear direction of the battery pack 2. The bottom plate portion 100 has its front end and rear end comprising fixation ribs 110 for fixing the first connection detection terminal 62a to the circuit board 42 (see FIG. 4). The fixation ribs 110 have a shape turned downward from the front and rear ends of the bottom plate portion 100.

The lower curved portion 102 is disposed on both sides in the left-right direction of the bottom plate portion 100. The lower curved portion 102 has a shape curved upward from the both ends of the bottom plate portion 100. The inclined portion 104 has a planar shape extending upward from upper ends of the lower curved portion 102. The inclined portion 104 is inclined relative to the bottom plate portion 100 such that an angle formed by the inclined portion 104 and the bottom plate portion 100 is an acute angle. The clamp portion 106 has a planar shape in which it extends from upper ends of the inclined portion 104 by turning slightly outward therefrom. The clamp portion 106 has its inclination angle adjusted so that a surface of the clamp portion 106 is in contact with a surface of the second connection detection terminal 206a (see FIG. 6) of the power tool 200 when the second connection detection terminal 206a engages with the first connection detection terminal 62a. The upper curved portion 108 has a shape curved outward from upper ends of the clamp portion 106. The clamp portion 106 has its rear end connected with rear ribs 112a. The rear ribs 112a have a shape curved rearward. The clamp portion 106 has its front end connected with front ribs 112b. The front ribs 112b have a shape curved frontward. Hereafter, the bottom plate portion 100 and the lower curved portion 102 may be collectively referred to as a base portion 114 of the first connection detection terminal 62a. In addition, the inclined portion 104, the clamp portion 106, and the upper curved portion 108 may be collectively referred to as a pair of elastic clamping pieces 116 of the first connection detection terminal 62a. That is, the first connection detection terminal 62a comprises the base portion 114 and the pair of elastic clamping pieces 116 extending upward from the base portion 114.

When the second connection detection terminal 206a (see FIG. 6) of the power tool 200 is inserted into the first connection detection terminal 62a, a front edge of the second connection detection terminal 206a enters the pair of elastic clamping pieces 116, and thereby the pair of elastic clamping pieces 116 spread wide outward, as a result of which the second connection detection terminal 206a is clamped by the pair of elastic clamping pieces 116. At this occasion, the clamp portion 106 is pressed against the second connection detection terminal 206a by elastic restoring force of the pair of elastic clamping pieces 116, the first connection detection terminal 62a mechanically engages with the second connection detection terminal 206a and electrically connects therewith. That is, the clamp portion 106 receives the second connection detection terminal 206a of the power tool 200 and clamps the second connection detection terminal 206a from both sides. Conversely, when the second connection detection terminal 206a of the power tool 200 is pulled out from the pair of elastic clamping pieces 116, the first connection detection terminal 62a and the second connection detection terminal 206a are mechanically disengaged from each other and thus electrically disconnected. Then, the pair of elastic clamping pieces 116 restore to their original positions by the elastic restoring force of the pair of elastic clamping pieces 116.

With reference to FIGS. 10 to 12, plating applied on each of the power terminals 60 and the signal terminals 62 of the battery pack 2 will be described.

The first positive power terminal 60a shown in FIG. 10 uses a Cu alloy as its base material 120. An entire surface of the first positive power terminal 60a is plated with Cu plating 122 as its basecoat plating, and Sn plating 124 is applied on top of the Cu plating 122. The first negative power terminal 60b is plated in the same way as the one on the first positive power terminal 60a. Alternatively, plating using a pure metal that is a base metal, such as Ni, may be applied instead of the Sn plating, and as another alternative, plating using a pure metal that is a noble metal other than Ag, such as Au, may be applied. As yet another alternative, plating using an alloy not containing Ag may be applied.

When the battery pack 2 is used in a high-moisture environment, metal on a surface of the first positive power terminal 60a may be ionized, move on the circuit board 42 toward the first negative power terminal 60b, and deposit as metal on a surface of the first negative power terminal 60b. Such a phenomenon is called ion migration. When the metal deposited on the first negative power terminal 60b grows on the circuit board 42, short-circuiting may occur in the circuit board 42. Ag is most prone to the ion migration. Further, since the ion migration tends to occur when a large voltage is applied while the ion migration tends not to occur when a small voltage is applied, it tends to occur in the power terminals 60 and tends not occur in the signal terminals 62. Due to this, as aforementioned, by applying plating using a pure metal other than Ag or plating using an alloy not containing Ag on the first positive power terminal 60a and the first negative power terminal 60b, the short-circuiting caused by the ion migration can be suppressed. Especially by applying plating using a pure metal other than Ag or plating using an alloy not containing Ag on the surface of the first positive power terminal 60a, Ag ionization on the surface of the first positive power terminal 60a can be suppressed, and the short-circuiting caused by the ion migration can be suppressed. The pure metal other than Ag or the alloy not containing Ag as aforementioned may be a pure metal other than Ag, Pb or an alloy not containing Ag, Pb, or may be a pure metal other than Ag, Pb, Cu or an alloy not containing Ag, Pb, Cu.

The first connection detection terminal 62a shown in FIG. 11 uses a Cu alloy as its base material 130. An entire surface of the first connection detection terminal 62a is plated with a Cu plating 132 as a basecoat plating. An inner surface of the tip section 109a (i.e., the clamp portion 106 and the upper curved portion 108) of the first connection detection terminal 62a is plated with Ag plating 134 on top of the basecoat plating, and inner surfaces of the intermediate section 109b (i.e., the inclined portion 104) and the base section 109c (i.e., the bottom plate portion 100 and the lower curved portion 102) of the first connection detection terminal 62a are not plated on top of the basecoat plating. Also, an outer surface of the first connection detection terminal 62a is not plated on top of the basecoat plating. The first discharge control terminal 62c and the first serial communication terminal 62d are plated in the same way as the one on the first connection detection terminal 62a. The tip section 109a may be plated with a pure metal that is a noble metal, such as Au, or noble metal alloy, instead of the Ag plating 134.

The first charge control terminal 62b shown in FIG. 12 uses a Cu alloy as its base material 130. An entire surface of the first charge control terminal 62b is plated with Cu plating 132 as a basecoat plating, and Sn plating 136 is applied on top of the Cu plating 132. Plating using a pure metal that is a base metal, such as Ni, may be applied instead of the Sn plating, and as another alternative, plating using a pure metal that is a noble metal other than Ag, such as Au, may be applied. As yet another alternative, plating using an alloy not containing Ag may be applied.

In the state in which the battery pack 2 is attached to the power tool 200 (FIG. 2), the signal terminals 62 are maintained in contact with the signal terminals of the power tool 200. When the power tool 200 operates, micro-vibration is repeatedly applied to the signal terminals 62. In this case, partial wear progresses on surfaces of the signal terminals 62, by which metal debris worn off of the surfaces of the signal terminals 62 oxidizes and accumulates on the surfaces of the signal terminals 62. Such a phenomenon is called fretting corrosion. As the oxidized debris accumulates on the surfaces of the signal terminals 62, conduction defects of the signal terminals 62 could occur. In general, noble metals tend not to oxidize, thus they are resistant against such conduction defects caused by the fretting corrosion. To the contrary, since base metals are prone to oxidization, they are susceptible to such conduction defects caused by the fretting corrosion. Further, the conduction defects caused by the fretting corrosion tends not to occur when a large voltage is applied whereas they tend to occur when a small voltage is applied, thus the conduction defects tend not to occur in the power terminals 60 and tend to occur in the signal terminals 62. Therefore, by plating the first connection detection terminal 62a, the first discharge control terminal 62c, and the first serial communication terminal 62d using a pure metal that is a noble metal or a noble metal alloy, the conduction defects caused by the fretting corrosion can be suppressed. Here, since the charger 300 (see FIG. 3) is usually used in a state placed on a ground, for example, the micro-vibration does not tend to be delivered to the signal terminals 62 when the battery pack 2 is attached to the charger 300. Due to this, fretting corrosion does not tend to occur in the first charge control terminal 62b which is connected to the third charge control terminal 306b (see FIG. 7) of the charger 300 but not connected to the terminals of the power tool 200. Due to this, plating using a pure metal that is a noble metal or a noble metal alloy is not applied on the first charge control terminal 62b. In general, a pure metal that is a noble metal or a noble metal alloy is expensive. Due to this, by minimizing an area which is plated with a pure metal that is a noble metal or a noble metal alloy, manufacturing cost of the battery pack 2 can be reduced.

Because only the tip section 109a of the first connection detection terminal 62a is plated with the Ag plating 134 as shown in FIG. 11, manufacturing cost of the battery pack 2 can be reduced as compared to a configuration where the tip section 109a, the intermediate section 109b, and the base section 109c of the first connection detection terminal 62a are all plated with the Ag plating 134. Further, a creepage distance between the first connection detection terminal 62a, the first discharge control terminal 62c, and the first serial communication terminal 62d can be made long. Due to this, even when the metal (i.e., Ag) on the surface of the first connection detection terminal 62a is ionized, metal deposition on the surfaces of the first discharge control terminal 62c and the first serial communication terminal 62d can be suppressed. Accordingly, occurrence of ion migration can be suppressed.

As aforementioned, the first connection detection terminal 62a is fabricated by cutting and bending a planar metal plate. The plating on the surfaces of the first connection detection terminal 62a is applied on the planar metal plate before being subjected to the cutting and bending. Specifically, the Cu plating 132 is firstly applied on a surface to be the inner surface of the first connection detection terminal 62a. Subsequently the Cu plating 132 is applied on a surface to be the outer surface of the first connection detection terminal 62a. Then, the Ag plating 134 is applied on parts to be the tip section 109a (i.e., the clamp portion 106 and the upper curved portion 108) of the inner surface of the first connection detection terminal 62a. If the Ag plating 134 is also to be applied on the outer surface of the tip section 109a, the Ag plating 134 needs to be firstly applied to the part to be the tip section 109a of the surface to be the inner surface of the first connection detection terminal 62a, and then the Ag plating 134 needs to be applied to the part to be the tip section 109a of the surface to be the outer surface of the first connection detection terminal 62a. In the present embodiment however, since the Ag plating 134 is not applied on the outer surface of the tip section 109a, manufacturing processes of the first connection detection terminal 62a can be simplified.

In one or more embodiments, the battery pack 2 is configured to be attached to and detached from the power tool 200 (example of “electric device”) including the plurality of terminals 202 (example of “plurality of device-side terminals”) having a planar shape or the charger 300 (example of “electric device”) including the plurality of terminals 302 (example of “plurality of device-side terminals”) having a planar shape. The battery pack 2 comprises the outer case 10; the battery cells 52 housed within the outer case 10; the circuit board 42 housed within the outer case 10; and the plurality of terminals 44 (example of “a plurality of battery-side terminals”). The plurality of terminals 44 includes the first connection detection terminal 62a (example of “first terminal”). The first connection detection terminal 62a includes the clamp portion 106, the clamp portion 106 being configured to receive the second connection detection terminal 206a or the third connection detection terminal 306a (examples of “a device-side terminal of the plurality of device-side terminals”) and clamp the second connection detection terminal 206a or the third connection detection terminal 306a from both sides. The inner surface of the clamp portion 106 is plated with the Ag plating 134 (example of “plated with a first metal”). The surfaces of the base portion 114 and the inclined portion 104 of the first connection detection terminal 62a (example of “non-clamp portion”) are not plated with the Ag plating 134.

In general, noble metals tend not to oxidize, thus they are resistant against such conduction defects caused by the fretting corrosion. To the contrary, since base metals are prone to oxidization, they are susceptible to such conduction defects caused by the fretting corrosion. Accordingly, occurrence of conduction defects due to fretting corrosion can be suppressed by plating the inner surfaces of the clamp portion 106 of the first connection detection terminal 62a with the Ag plating 134. Also, generally, the noble metals are expensive. According to the above configuration, compared to a configuration where surfaces of the base portion 114 and the inclined portion 104 of the first connection detection terminal 62a are also plated with the Ag plating 134, manufacturing costs of the battery pack 2 can be reduced. A contact resistance of Ag is smaller than a contact resistance of Sn. Accordingly, the Ag plating 134 on the inner surfaces of the clamp portion 106 of the first connection detection terminal 62a allows the contact resistance of the first connection detection terminal 62a to be reduced.

In one or more embodiments, the first connection detection terminal 62a is a terminal for transmitting a signal to and from the power tool 200/the charger 300.

The conduction defects caused by the fretting corrosion tend not to occur when a large voltage is applied whereas the conduction defects tend to occur when a small voltage is applied, thus the conduction defects tend to occur in the signal terminal(s) 62. According to the above configuration, occurrence of the conduction defects due to fretting corrosion can be suppressed by plating the surface of the first connection detection terminal 62a which is one of the signal terminals 62 with the Ag plating 134.

In one or more embodiments, the plurality of terminals 44 further include the first charge control terminal 62b (example of “a second terminal”), which is one of the signal terminals 62, for transmitting a signal to and from the power tool 200/the charger 300. The first charge control terminal 62b is not plated with the Ag plating 134.

The plurality of signal terminals comprised by the battery pack 2 includes signal terminals which are susceptible to fretting corrosion and signal terminals which are insusceptible to fretting corrosion. The first connection detection terminal 62a is a signal terminal which is more susceptible to fretting corrosion than the first charge control terminal 62b. According to the above configuration, the first connection detection terminal 62a more susceptible to fretting corrosion is preferentially plated with Ag. Accordingly, the effects by fretting corrosion can be suppressed and also manufacturing costs of the battery pack 2 can be decreased.

In one or more embodiments, under a state where the battery pack 2 is attached to the power tool 200, the second connection detection terminal 206a (example of “the first device-side terminal”) is in contact with the first connection detection terminal 62a, and none of the plurality of terminals 202 of the power tool 200 are in contact with the first charge control terminal 62b. Under a state where the battery pack 2 is attached to the charger 300, the third connection detection terminal 306a (example of “second device-side terminal”) is in contact with the first connection detection terminal 62a, and the third charge control terminal 306b (example of “third device-side terminal”) is in contact with the first charge control terminal 62b.

Micro vibration is less likely when the battery pack 2 is attached to the charger 300 than when the battery pack 2 is attached to the power tool 200. Due to this, fretting corrosion is less likely on the first charge control terminal 62b which contacts the third charge control terminal 306b of the charger 300 but not contact any terminal of the power tool 200. That is, the first charge control terminal 62b is a signal terminal which is less susceptible to fretting corrosion than the first connection detection terminal 62a. Due to this, there is less necessity for plating the first charge control terminal 62b with the Ag plating 134. According to the above configuration, the first charge control terminal 62b is not plated with the Ag plating 134. Accordingly, the effects by fretting corrosion can be suppressed, and also manufacturing costs of the battery pack 2 can be decreased.

In one or more embodiments, the outer surface of the clamp portion 106 is not plated with Ag plating 134.

The inner surfaces of the clamp portion 106 contacts the second connection detection terminal 206a or the third connection detection terminal 306a, while the outer surfaces of the clamp portion 106 does not contact the second connection detection terminal 206a or the third connection detection terminal 306a. Due to this, fretting corrosion occurs on the inner surfaces of the clamp portion 106 but it does not occur on the outer surfaces of the clamp portion 106. According to the above configuration, the inner surfaces of the clamp portion 106 where fretting corrosion occurs is only plated with the Ag plating 134, and accordingly manufacturing costs of the battery pack 2 can be decreased as compared to the configuration where the outer surfaces of the clamp portion 106 are also plated with the Ag plating 134.

In one or more embodiments, the battery pack 2 is configured to be attached to and detached from the power tool 200 by sliding the battery pack 2 with respect to the power tool 200 in the front-rear direction (example of “a sliding direction”) along the terminals 202. The first connection detection terminal 62a includes: the base portion 114; and the pair of elastic clamping pieces 116 extending from the base portion 114 upward. The base portion 114 includes the bottom plate portion 100 extending along the front-rear direction. Each of the elastic clamping pieces 116 in the pair includes the inclined portion 104 and the clamp portion 106 disposed above the inclined portion 104. The inclined portion 104 is inclined with respect to the bottom plate portion 100 such that an angle formed by the inclined portion 104 and the bottom plate portion 100 is an acute angle. The base portion 114 and the inclined portion 104 are a part of the non-clamp portion.

According to the above configuration, each of the elastic clamping pieces 116 in the pair extends in the up-down direction. Accordingly, in order to increase a contact area between the second connection detection terminal 206a or the third connection detection terminal 306a and the first connection detection terminal 62a, a width of the pair of elastic clamping pieces 116 may be increased. Normally, there is often an enough space in the front-rear direction inside the battery pack 2. Accordingly, even when the width of the pair of elastic clamping pieces 116 is increased in the front-rear direction, size of the battery pack 2 will not be increased. According to the above battery pack 2, without increase in the size of the battery pack 2, the contact area between the second connection detection terminal 206a or the third connection detection terminal 306a and the first connection detection terminal 62a can be increased.

### SECOND EMBODIMENT

An adapter 400 shown in FIG. 13 is a device for electrically connecting the power tool 200 (see FIG. 2) with one or more battery packs 2 (see FIG. 1) or a power supply (not shown). Hereafter, features common between the embodiments will be denoted by the same reference numerals and descriptions thereof may be omitted.

The adapter 400 comprises an outer case 402, a control unit 404 (see FIG. 14) housed within the outer case 402, and a cord 406. The outer case 402 has a shape of a substantially cuboid as a whole, and is divided into an upper case 408 and a lower case 410. The upper case 408 and the lower case 410 are fixed to each other by metal screws (not shown).

As shown in FIG. 14, the control unit 404 comprises the circuit board 420 and a plurality of terminals 422. The circuit board 420 is fixed to the lower case 410 via screws 424. The plurality of terminals 422 comprises power terminals 60 and signal terminals 462. The signal terminals 462 comprise a first connection detection terminal 62a arranged adjacent to and on the right side of the first positive power terminal 60a, a first discharge control terminal 62c arranged adjacent to and on the right side of the first connection detection terminal 62a, and a first serial communication terminal 62d arranged adjacent to and in front of the first discharge control terminal 62c. That is, the signal terminals 462 of the adapter 400 do not comprise a terminal corresponding to the first charge control terminal 62b (see FIG. 4) of the battery pack 2 of the first embodiment. The cord 406 is electrically connected to the circuit board 420. The cord 406 electrically couples the one or more battery packs 2 (see FIG. 1) or the power supply (not shown) to the adapter 400.

As shown in FIG. 10, the first positive power terminal 60a in the adapter 400 of the present embodiment uses a Cu alloy as a base material 120, and an entire surface of the first positive power terminal 60a is plated with Cu plating 122 as a basecoat plating, and Sn plating 124 is applied on top of the basecoat plating. The first negative power terminal 60b is plated in the same manner as the one on the first positive power terminal 60a. Plating using a pure metal that is a base metal, such as Ni, may be applied instead of the Sn plating, and as another alternative, plating using a pure metal that is a noble metal other than Ag, such as Au, may be applied. As yet another alternative, plating using an alloy not containing Ag may be applied.

As shown in FIG. 11, the first connection detection terminal 62a of the present embodiment comprise a Cu alloy as a base material 130, and an entire surface of the first connection detection terminal 62a is plated with the Cu plating 132 as a basecoat plating. The tip section 109a of the inner surface of the first connection detection terminal 62a is plated with the Ag plating 134 on top of the basecoat plating, and the base section 109c of the inner surface of the first connection detection terminal 62a is not plated on top of the basecoat plating. The first discharge control terminal 62c and the first serial communication terminal 62d are plated in the same manner as the one on the first connection detection terminal 62a. Here, at the tip section 109a, a plating using a pure metal that is a noble metal such as Au or a noble metal alloy may be applied instead of the Ag plating 134.

As mentioned above, in one or more embodiments, the adapter 400 is configured to be attached to and detached from the power tool 200 (example of “an electric device”) including the plurality of terminals 202 (example of “plurality of device-side terminals”) having a planar shape. The adapter 400 comprises the outer case 402; the circuit board 420 housed within the outer case 402; the cord 406 (example of “a connected portion”) electrically connected with the circuit board 420; and the plurality of terminals 422 (example of “a plurality of adapter-side terminals”). The plurality of terminals 422 includes the first connection detection terminal 62a (example of “a first terminal”). The first connection detection terminal 62a includes the clamp portion 106, the clamp portion 106 being configured to receive the second connection detection terminal 206a (example of “a device-side terminal of the plurality of device-side terminals”) and clamp the second connection detection terminal 206a from both sides. The inner surfaces of the clamp portion 106 are plated with the Ag plating 134 (example of “plated with a first metal”). The surfaces of the base portion 114 and the inclined portion 104 of the first connection detection terminal 62a (example of “the non-clamp portion”) are not plated with the Ag plating 134.

In general, noble metals tend not to oxidize, thus they are resistant against such conduction defects caused by the fretting corrosion. To the contrary, since base metals are prone to oxidization, they are susceptible to such conduction defects caused by the fretting corrosion. Accordingly, occurrence of conduction defects due to fretting corrosion can be suppressed by plating the inner surfaces of the clamp portion 106 of the first connection detection terminal 62a with the Ag plating 134. Also, generally, the noble metals are expensive. According to the above configuration, as compared to a configuration where the surfaces of the base portion 114 and the inclined portion 104 of the first connection detection terminal 62a are also plated with the Ag plating 134, manufacturing costs of the adapter 400 can be reduced.

### THIRD EMBODIMENT

With reference to FIGS. 15 and 16, a signal terminal 562 which a battery pack according to a third embodiment comprises will be described. In FIGS. 15 and 16, parts plated with Ag plating 134 are shown with shades.

The signal terminal 562 shown in FIG. 15 is fabricated by cutting and bending a planar metal plate. The signal terminal 562 comprises a bottom plate portion 570, a right clamping piece 572, and a left clamping piece 574. The bottom plate portion 570 has a rectangular shape a longitudinal direction of which extends along the front-rear direction of the battery pack 2. The bottom plate portion 570 has its front end and rear end comprising fixation ribs 576 for fixing the signal terminal 562 to the circuit board 42 (see FIG. 4). The fixation ribs 576 have a shape turned downward from the front and rear ends of the bottom plate portion 570.

The left clamping piece 574 has a symmetrical shape in the left-right direction relative to the right clamping piece 572. Hereinafter, the right clamping piece 572 will be described, and a description for the left clamping piece 574 will be omitted.

The right clamping piece 572 comprises an outer plate portion 580, a first rear curved portion 582, a rear plate portion 584, a second rear curved portion 586, an inclined portion 588, a clamp portion 590, and a front curved portion 592. The first rear curved portion 582, the rear plate portion 584, the second rear curved portion 586, the inclined portion 588, the clamp portion 590, and the front curved portion 592 are arranged at a tip section 594a of the signal terminal 562, and the bottom plate portion 570 is arranged at a base section 594b of the signal terminal 562. That is, the clamp portion 590 is arranged at a part of the tip section 594a.

The outer plate portion 580 extends upward from a right end of the bottom plate portion 570. The rear plate portion 584 has a rectangular shape a longitudinal direction of which extends along the front-rear direction of a battery pack. The first rear curved portion 582 has a shape curved leftward from a rear end of the outer plate portion 580. The first rear curved portion 582 connects the rear end of the outer plate portion 580 to a right end of the rear plate portion 584. The second rear curved portion 586 has a shape curved frontward from the right end of the rear plate portion 584. The second rear curved portion 586 connects a left end of the rear plate portion 584 with a rear end of the inclined portion 588. The inclined portion 588 is inclined such that its front side is inclined leftward. The inclined portion 588 is inclined relative to the rear plate portion 584 such that an angle formed by the inclined portion 588 and the rear plate portion 584 is an obtuse angle. The clamp portion 590 has a planar shape in which it extends from a front end of the inclined portion 588 by turning slightly outward (rightward) therefrom. The clamp portion 590 has its inclination angle adjusted so that a surface of the clamp portion 590 is in contact with a surface of the second connection detection terminal 206a (see FIG. 6) when the second connection detection terminal 206a (see FIG. 6) of the power tool 200 engages with the signal terminal 562. The front curved portion 592 has a shape curved outward (rightward) from an upper end of the clamp portion 590. Hereafter, the first rear curved portion 582, the rear plate portion 584, and the second rear curved portion 586 may be collectively referred to as a base portion 596 of the signal terminal 562. In addition, the inclined portion 588, the clamp portion 590, and the front curved portion 592 may be collectively referred to as a pair of elastic clamping pieces 598 of the signal terminal 562. That is, the signal terminal 562 comprises the base portion 596 and the plurality of pairs of elastic clamping pieces 598 extending frontward from the base portion 596.

When the second connection detection terminal 206a (see FIG. 6) of the power tool 200 is inserted into the signal terminal 562, a front edge of the second connection detection terminal 206a enters between front ends of the pairs of elastic clamping pieces 598, and thereby the pairs of elastic clamping pieces 598 spread outward, as a result of which the second connection detection terminal 206a is clamped by the pairs of elastic clamping pieces 598. At this occasion, the clamp portion 590 is pressed against the second connection detection terminal 206a by elastic restoring force of the pairs of elastic clamping pieces 598, the signal terminal 562 mechanically engages with the second connection detection terminal 206a and electrically connects therewith. That is, the clamp portion 590 receives the second connection detection terminal 206a of the power tool 200 and clamps the second connection detection terminal 206a from both sides. Conversely, when the second connection detection terminal 206a of the power tool 200 is pulled out from the pairs of elastic clamping pieces 598, the signal terminal 562 and the second connection detection terminal 206a are mechanically disengaged from each other and thus electrically disconnected. Then, the pairs of elastic clamping pieces 598 restore to their original positions by elastic restoring force of the second rear curved portion 586 and the inclined portion 588.

With reference to FIG. 16, plating applied on a surface of the signal terminal 562 will be described. An entire surface of the signal terminal 562 is plated with Cu plating as a basecoat plating.

As shown in FIG. 16, in the tip section 594a of the signal terminal 562, the Ag plating 134 is applied on top of the basecoat plating on left surfaces (i.e., inside the signal terminal 562) of the inclined portion 588, the clamp portion 590, and the front curved portion 592. In the signal terminal 562, no plating is applied on top of the basecoat plating on another surface part besides the inner surfaces of the inclined portion 588, the clamp portion 590, and the front curved portion 592. Alternatively, in the tip section 594a, plating using a pure metal that is a noble metal such as Au or a noble metal alloy may be applied instead of the Ag plating 134.

In the present embodiment, the outer plate portion 580 and the base portion 596 are an example of “part of the non-clamp portion”.

The power terminals of the battery pack may have a same shape as that of the signal terminal 562. Further, the signal terminal 562 as aforementioned may be implemented in the adapter.

In one or more embodiments, the battery pack 2 is configured to be attached to and detached from the power tool 200 by sliding the battery pack 2 with respect to the power tool 200 in the front-rear direction (sliding direction) along the terminals 202. The signal terminal 562 includes: a pair of the outer plate portions 580 (example of pair of planar portions) connected to the circuit board 42; and the pairs of elastic clamping pieces 598 integrated with the pair of outer plate portions 580, disposed above the circuit board 42, and extending in the front-rear direction. Each of the elastic clamping pieces in the pairs includes the clamp portion 590. The base section 594b of the pair of outer plate portions 580 (example of a part which is closer to the circuit board) is a part of the non-clamp portion.

According to the above configuration, each of the pairs of elastic clamping pieces 598 extends along the front-rear direction. According to such configuration, the second connection detection terminal 206a of the power tool 200 can be easily slid between the pairs of elastic clamping pieces 598.

(First Modification) In the first embodiment and the second embodiment, the first positive power terminal 60a and the first negative power terminal 60b may be plated with the same plating as that on the first connection detection terminal 62a.

(Second Modification) In the first embodiment, the first charge control terminal 62b may be plated with the same plating as that on the first connection detection terminal 62a.

(Third Modification) An outer surface of the clamp portion 106 of the first connection detection terminal 62a, specifically on an outer surface of the tip section 109a, may be plated with the Ag plating 134.

(Fourth Modification) The inner surface of the clamp portion 106 of the first connection detection terminal 62a may be plated with the Ag plating 134. That is, the inner surface of the upper curved portion 108 of the first connection detection terminal 62a may not be plated with the Ag plating 134.

(Fifth Modification) A part of the inner surface of the inclined portion 104 of the first connection detection terminal 62a may be plated with the Ag plating 134.

(Sixth Modification) In the first embodiment, the inner surface of the clamp portion 106 of the first discharge control terminal 62c (example of “first terminal”) may be plated with the Ag plating 134, while the first serial communication terminal 62d (example of “second terminal”) may not plated with the Ag plating 134. The first discharge control terminal 62c for transmitting a discharge enable signal or a discharge disable signal to and from the power tool 200 is more susceptible to fretting corrosion than the first serial communication terminal 62d. According to the above configuration, the first discharge control terminal 62c which is susceptible to fretting corrosion is preferentially plated with the Ag plating 134. Accordingly, the effects by fretting corrosion can be suppressed and also manufacturing costs of the battery pack 2 can be decreased. Alternatively, in another Modification, the first connection detection terminal 62a may not be plated with the Ag plating 134, either. In other words, the first discharge control terminal 62c only may be plated with the Ag plating 134.

(Seventh Modification) In the first and second embodiments, the inner surface of the tip section 109a (i.e., the clamp portion 106 and the upper curved portion 108) of the first connection detection terminal 62a may be plated with the Cu plating 132 as a basecoat plating. That is, the region which is plated with the Cu plating 132 and the region which is plated with the Ag plating 134 may be the same as each other.

(Eighth Modification) In the tip section 594a of the signal terminal 562 shown in FIG. 17, in addition to the left surfaces of the inclined portion 588, the clamp portion 590, and the front curved portion 592, a right surface of an upper part of the outer plate portion 580, a right surface of the first rear curved portion 582, a rear surface of the rear plate portion 584 (see FIG. 18), and a left surface of the second rear curved portion 586 (see FIG. 18) may also be plated with the Ag plating 134 on top of the basecoat plating.

What is claimed is:

1. A battery pack configured to be attached to and detached from an electric device including a plurality of device-side terminals having a planar shape, the battery pack comprising:
an outer case;
a battery cell housed within the outer case;
a circuit board housed within the outer case; and
a plurality of battery-side terminals,
wherein the plurality of battery-side terminals incudes a first terminal,
the first terminal includes a clamp portion and a non-clamp portion, the clamp portion being configured to receive a device-side terminal of the plurality of device-side terminals and clamp the device-side terminal from both sides, and the non-clamp portion being disposed at a position different from the clamp portion,
an inner surface of the clamp portion is plated with a first metal;
a part of a surface of the non-clamp portion is not plated with the first metal, wherein
the first metal is a pure metal that is a noble metal or a noble metal alloy.

2. The battery pack according to claim 1, wherein
the first terminal is a terminal for transmitting a signal to and from the electric device.

3. The battery pack according to claim 2, wherein
the plurality of battery-side terminals further incudes a second terminal for transmitting a signal to and from the electric device, wherein
the second terminal is not plated with the first metal.

4. The battery pack according to claim 3, wherein
in a case where the electric device is a power tool, the plurality of device-side terminals of the power tool includes a first device-side terminal,
under a state where the battery pack is attached to the power tool,
the first device-side terminal is in contact with the first terminal, and
none of the plurality of device-side terminals of the power tool are in contact with the second terminal, and
wherein in a case where the electric device is a charger, the plurality of device-side terminals of the charger includes a second device-side terminal and a third device-side terminal different from the second device-side terminal, and
under a state where the battery pack is attached to the charger,
the second device-side terminal is in contact with the first terminal, and
the third device-side terminal is in contact with the second terminal.

5. The battery pack according to claim 3, wherein
the first terminal is a terminal for transmitting a discharge enable signal or a discharge disable signal to and from the electric device.

6. The battery pack according to claim 1, wherein
an outer surface of the clamp portion is not plated with the first metal.

7. The battery pack according to claim 1, wherein
the first metal is Ag.

8. The battery pack according to claim 1, wherein
the battery pack is configured to be attached to and detached from the electric device by sliding the battery pack with respect to the electric device in a sliding direction along the device-side terminals,
each of the battery-side terminals includes:
a base portion; and
a pair of elastic clamping pieces extending from the base portion upward which is orthogonal to the sliding direction,
wherein the base portion includes a bottom plate portion extending along the sliding direction,
each of the elastic clamping pieces in the pair includes an inclined portion and the clamp portion disposed above the inclined portion, and
the inclined portion is inclined with respect to the base portion such that an angle formed by the inclined portion and the bottom plate portion is an acute angle,
wherein the base portion and the inclined portion are a part of the non-clamp portion.

9. The battery pack according to claim 1, wherein
the battery pack is configured to be attached to and detached from the electric device by sliding the battery pack with respect to the electric device in a sliding direction along the device-side terminals, and
each of the battery-side terminals includes:
a pair of planar portions connected to the circuit board; and
a pair of elastic clamping pieces integrated with the pair of planar portions, disposed above the circuit board, and extending in the sliding direction, and
each of the elastic clamping pieces in the pair includes the clamp portion,
wherein a part of the pair of planar portions which is closer to the circuit board is a part of the non-clamp portion.

10. An adapter configured to be attached to and detached from an electric device including a plurality of device-side terminals having a planar shape, the adapter comprising:
an outer case;
a circuit board housed within the outer case;
a connected portion electrically connected with the circuit board; and
a plurality of adapter-side terminals,
wherein the plurality of adapter-side terminals incudes a first terminal,
the first terminal includes a clamp portion and a non-clamp portion, the clamp portion being configured to receive a device-side terminal of the plurality of device-side terminals and clamp the device-side terminal from both sides, and the non-clamp portion being disposed at a position different from the clamp position,
at least a part of a surface of the clamp portion is plated with a first metal,
a part of a surface of the non-clamp portion is not plated with the first metal, and
the first metal is a pure metal that is a noble metal or a noble metal alloy.

11. The adapter according to claim 10, wherein
the first terminal is a terminal for transmitting a signal to and from the electric device.

12. The adapter according to claim 11, wherein
the plurality of battery-side terminals further incudes a second terminal for transmitting a signal to and from the electric device, wherein
the second terminal is not plated with the first metal.

13. The adapter according to claim 12, wherein
the first terminal is a terminal for transmitting a discharge enable signal or discharge disable signal to and from the electric device.

14. The adapter according to claim 10, wherein
an outer surface of the clamp portion is not plated with the first metal.

15. The adapter according to claim 10, wherein
the first metal is Ag.

16. The adapter according to claim 10, wherein
the adapter is configured to be attached to and detached from the electric device by sliding the adapter with respect to the electric device in a sliding direction along the device-side terminals,
each of the adapter-side terminals includes:
a base portion; and
a pair of elastic clamping pieces extending from the base portion upward which is orthogonal to the sliding direction,
wherein the base portion includes a bottom plate portion extending along the sliding direction,
each of the elastic clamping pieces in the pair includes an inclined portion and the clamp portion disposed above the inclined portion, and
the inclined portion is inclined with respect to the bottom plate portion such that an angle formed by the inclined portion and the base portion is an acute angle,
wherein the base portion and the inclined portion are a part of the non-clamp portion.

17. The adapter according to claim 10, wherein
the adapter is configured to be attached to and detached from the electric device by sliding the adapter with respect to the electric device in a sliding direction along the device-side terminals,
each of the adapter-side terminals includes:
a pair of planar portions connected to the circuit board; and
a pair of elastic clamping pieces integrated with the pair of planar portions, disposed above the circuit board, and extending in the sliding direction, and
each of the elastic clamping pieces in the pair includes the clamp portion,
wherein a part of the pair of planar portions which is closer to the circuit board is a part of the non-clamp portion.

18. A battery pack configured to be attached to and detached from an electric device including a plurality of device-side terminals having a planar shape, the battery pack comprising:
an outer case;
a battery cell housed within the outer case;
a circuit board housed within the outer case; and
a plurality of battery-side terminals,
wherein the plurality of battery-side terminals incudes a first terminal,
the first terminal includes a clamp portion and a non-clamp portion, the clamp portion being configured to receive a device-side terminal of the plurality of device-side terminals and clamp the device-side terminal from both sides, and the non-clamp portion being disposed at a position different from the clamp portion,
an inner surface of the clamp portion is plated with a first metal;
a part of a surface of the non-clamp portion is not plated with the first metal, wherein
the first metal is a pure metal that is a noble metal or a noble metal alloy,
wherein the first terminal is a terminal for transmitting a signal to and from the electric device,
wherein the plurality of battery-side terminals further incudes a second terminal for transmitting a signal to and from the electric device,
the second terminal is not plated with the first metal,
wherein in a case where the electric device is a power tool, the plurality of device-side terminals of the power tool includes a first device-side terminal,
under a state where the battery pack is attached to the power tool,
the first device-side terminal is in contact with the first terminal, and
none of the plurality of device-side terminals of the power tool are in contact with the second terminal, and
wherein in a case where the electric device is a charger, the plurality of device-side terminals of the charger includes a second device-side terminal and a third device-side terminal different from the second device-side terminal,
under a state where the battery pack is attached to the charger,
the second device-side terminal is in contact with the first terminal, and
the third device-side terminal is in contact with the second terminal,
wherein the first terminal is a terminal for transmitting a discharge enable signal or a discharge disable signal to and from the electric device,
wherein an outer surface of the clamp portion is not plated with the first metal,
wherein the first metal is Ag,
wherein the battery pack is configured to be attached to and detached from the electric device by sliding the battery pack with respect to the electric device in a sliding direction along the device-side terminals,
wherein each of the battery-side terminals includes:
a base portion; and a pair of elastic clamping pieces extending from the base portion upward which is orthogonal to the sliding direction, wherein the base portion includes a bottom plate portion extending along the sliding direction, each of the elastic clamping pieces in the pair includes an inclined portion and the clamp portion disposed above the inclined portion, and the inclined portion is inclined with respect to the base portion such that an angle formed by the inclined portion and the bottom plate portion is an acute angle, wherein the base portion and the inclined portion are a part of the non-clamp portion; or
a pair of planar portions connected to the circuit board; and a pair of elastic clamping pieces integrated with the pair of planar portions, disposed above the circuit board, and extending in the sliding direction, and each of the elastic clamping pieces in the pair includes the clamp portion, wherein a part of the pair of planar portions which is closer to the circuit board is a part of the non-clamp portion.
